(19) United States
(12) Patent Application Publication
(10) Pub. No.: US 2023/0211805 A1
(43) Pub. Date: Jul. 6, 2023

(54) Concept For Supporting a Motor Vehicle Being Guided in at Least Partially Automated Manner

(71) Applicants: Robert Bosch GmbH, Stuttgart-Feuerbach (DE); ASFINAG Maut Service GmbH, Vienna (AT)

(72) Inventors: Stefan Nordbruch, Leonberg (DE); Michael Gabb, Gaufelden (DE); Uwe Wilbrand, Leutenbach (DE); Nico Latsch, Oppenweiler (DE); Jacqueline Erhart, Vienna (AT); Yannick Wimmer; Friedrich Vogl, Klagenfurt am Wörthersee (AT)

(73) Assignees: Robert Bosch GmbH, Stuttgart-Feuerbach (DE); ASFINAG Maut Service GmbH, Vienna (AT)

(21) Appl. No.: 18/183,431

(22) Filed: Mar. 14, 2023

Related U.S. Application Data
(63) Continuation of application No. PCT/EP2021/075166, filed on Sep. 14, 2021.

(30) Foreign Application Priority Data
Sep. 14, 2020 (DE) 102020123831.2

(51) Int. Cl. B60W 60/00; G05D 1/00; H04W 4/44

(52) U.S. Cl. CPC B60W 60/0015; G05D 1/0022; H04W 4/44; B60W 2552/00; B60W 2556/45

(57) ABSTRACT

A method for at least partially automated driving of a motor vehicle includes the steps of: determining that a need exists for infrastructure-based, at least partially automated driving of the motor vehicle, and transmitting, via a communication network, a request to transmit a plurality of infrastructure data based on which the motor vehicle is drivable in an at least partially automated manner, in response to determining that a need exists for infrastructure-based, at least partially automated driving of the motor vehicle. Receiving, via the communication network, the infrastructure data in response to transmitting the request. Generating a plurality of control signals for at least partially automated controlling of a lateral and/or a longitudinal operation of the motor vehicle based on the infrastructure data, and outputting the generated control signals.

### CROSS-REFERENCE TO RELATED APPLICATIONS

This application is a continuation of PCT International Application No. PCT/EP2021/075166, filed on Sep. 14, 2021, which claims priority under 35 U.S.C. § 119 to German Patent Application No. 102020123831.2, filed on Sep. 14, 2020.

### FIELD OF THE INVENTION

The invention relates to a method for at least partially automated driving of a motor vehicle. The invention further relates to a method for infrastructure-based support for an at least partially automated operation of a motor vehicle. The invention relates to a device, a computer program and a machine-readable storage medium.

### BACKGROUND

German patent application DE 10 2013 001 326 A1 discloses a motor vehicle that is embodied to exchange operating data with a traffic object located in an environment of the motor vehicle and thereby to coordinate a driving maneuver of the motor vehicle with the traffic object.

### SUMMARY

A method for at least partially automated driving of a motor vehicle includes the steps of: determining that a need exists for infrastructure-based, at least partially automated driving of the motor vehicle, and transmitting, via a communication network, a request to transmit a plurality of infrastructure data based on which the motor vehicle is drivable in an at least partially automated manner, in response to determining that a need exists for infrastructure-based, at least partially automated driving of the motor vehicle. Receiving, via the communication network, the infrastructure data in response to transmitting the request. Generating a plurality of control signals for at least partially automated controlling of a lateral and/or a longitudinal operation of the motor vehicle based on the infrastructure data, and outputting the generated control signals.

### BRIEF DESCRIPTION OF THE DRAWINGS

Examples of embodiments of the invention are shown in the drawings and described in more detail in the following description. The Figures show:

FIG. 1 is a flowchart of a method according to the first aspect;

FIG. 2 is a device;

FIG. 3 is a machine-readable storage medium;

FIG. 4 is a first tunnel;

FIG. 5 is a second tunnel;

FIG. 6 is a flowchart of a method;

FIG. 7 is a flowchart of a method;

FIG. 8 is several motor vehicles within an infrastructure;

FIG. 9 is a flowchart of a method;

FIG. 10 is a flowchart of a method; and

FIG. 11 is a flowchart of a method according to the second aspect.

### DETAILED DESCRIPTION OF THE EMBODIMENT(S)

As a rule, a motor vehicle that is operated in an at least partially automated manner detects its environment using one or a plurality of environmental sensors and controls lateral and/or longitudinal operation of the motor vehicle in an at least partially automated manner based on this environment detection.

Now, according to the concept described below, it is advantageously possible in particular to use the infrastructure data in addition to the environment detection carried out internally in the motor vehicle in order to control the lateral and/or longitudinal operation of the motor vehicle in an at least partially automated manner. This means that more knowledge is available for this driving task compared with the case in which the motor vehicle is operated in an at least partially automated manner based only on data or information generated internally in the motor vehicle.

The terms “environment” and “surroundings” may be used synonymously.

In an embodiment, position signals representing a position of the motor vehicle are provided to be received, wherein the determination that a need exists for infrastructure-based, at least partially automated driving of the motor vehicle is carried out on the basis of the position of the motor vehicle. This e. g. achieves the technical advantage that the determination may be carried out efficiently.

Based on the position, an embodiment provides that the motor vehicle is localized, in particular localized on a digital map. According to an embodiment, the digital map comprises information at which locations or positions a need for infrastructure-based, at least partially automated driving of a motor vehicle exists. If, for example, based on the localization of the motor vehicle in the digital map, it is determined that a distance of the motor vehicle to such a location or to such a position is less than or equal to a predetermined threshold value, it is determined according to an embodiment that a need exists for infrastructure-based, at least partially automated driving of the motor vehicle.

For example, according to an embodiment, it is determined that a need exists for infrastructure-based, at least partially automated driving of the motor vehicle if a target route of the motor vehicle comprises such a position or location.

For example, according to an embodiment, it is provided that it is determined that a need exists for infrastructure-based, at least partially automated driving of the motor vehicle when it is detected that the motor vehicle is in a predetermined traffic situation. The detection that the motor vehicle is in a predetermined traffic situation may e. g. be carried out on the basis of environmental signals that represent an environment of the motor vehicle.

A predetermined traffic situation e. g. comprises one of the following traffic situations: road works, a bridge, a freeway access road, a freeway interchange, a dangerous and/or a complicated road section, a traffic jam, a traffic circle, a bus stop, a parking lot.

In an embodiment, determining whether there is a need for infrastructure-based, at least partially automated driving of the motor vehicle is carried out depending on a receipt of a communication message from the infrastructure server, wherein the communication message comprises information that infrastructure support is available at a predetermined position. The predetermined position is, for example, comprised by a target route of the motor vehicle.

This particularly means that e. g. the infrastructure server transmits the communication message, in particular transmits it to the motor vehicle.

The communication message e. g. comprises information on whether infrastructure-based, at least partially automated driving of the motor vehicle is optional or mandatory. Mandatory may e. g. result from a legal provision.

According to an embodiment, the communication network comprises a wireless communication network. According to an embodiment, a wireless communication network comprises a cellular network and/or a WLAN network. According to an embodiment, the communication network comprises the Internet.

In an embodiment, the method according to the first aspect comprises an at least partially automated control of the lateral and/or longitudinal operation of the motor vehicle based on the output control signals.

In an embodiment, it is provided that a position of the motor vehicle is determined. In an embodiment, it is provided that the motor vehicle is localized based on the position of the motor vehicle, in particular localized in a digital map.

In an embodiment, in response to determining that there is a need for infrastructure-based, at least partially automated driving of the motor vehicle, log-on data is sent over the communication network to log on the motor vehicle with a remote infrastructure server and to establish a communication link between the infrastructure server and the logged-on motor vehicle, wherein the infrastructure data is received from the infrastructure server over the established communication link.

This e. g. achieves the technical advantage that the infrastructure may efficiently obtain knowledge as to which motor vehicle is requesting the infrastructure data. Furthermore, the logon of the motor vehicle to the remote infrastructure server particularly provides the technical advantage that the infrastructure data is sent only to an authorized motor vehicle.

This particularly means that an authorization may be checked during the log-on process to determine whether the infrastructure data may be sent to the motor vehicle at all.

According to an embodiment, the received infrastructure data is checked, wherein the control signals are generated based on a result of checking the received infrastructure data.

This e. g. achieves the technical advantage that the control signals may be generated efficiently. In particular, this has the technical advantage that errors in the infrastructure data may be detected efficiently. For example, it is provided that the received infrastructure data are checked for plausibility.

In an embodiment, motor vehicle data signals representing motor vehicle data generated by the motor vehicle are received, the received infrastructure data are fused with the motor vehicle data to determine fused infrastructure motor vehicle data, wherein the control signals are generated based on the infrastructure motor vehicle data. This e. g. results in the technical advantage that the control signals may be generated efficiently.

Motor vehicle data e. g. comprise environmental sensor data from one or from a plurality of environmental sensors of the motor vehicle. Environmental sensor data e. g. represent an environment or surroundings of the motor vehicle. For example, motor vehicle data comprise speed data indicating a motor vehicle speed. For example, motor vehicle data comprise diagnostic data from one or from a plurality of motor vehicle systems. For example, motor vehicle data include tire pressure data indicating a tire pressure of one or of several tires of the motor vehicle. Motor vehicle data e. g. comprise status data indicating a respective status of one or of a plurality of motor vehicle systems of the motor vehicle. A motor vehicle system is e. g. .one of the following: a drive system, a steering system, a clutch system, a brake system, a lighting system, a driver assisting system.

In an embodiment, it is provided that it is checked whether at least one safety condition for an infrastructure-based, at least partially automated driving of the motor vehicle is fulfilled, wherein the control signals are generated based on a result of the checking whether the at least one safety condition for an infrastructure-based, at least partially automated driving of the motor vehicle is fulfilled.

This e. g. achieves technical advantage that the control signals may be generated efficiently. In particular, this achieves the technical advantage that it may be efficiently ensured that certain conditions, in this case the safety condition, for using the infrastructure data for at least partially automated driving of the motor vehicle are met. In particular, this has the technical advantage that, if the safety condition is met, it is then possible to use the infrastructure data reliably for at least partially automated driving of the motor vehicle.

According to an embodiment, a prerequisite for using the infrastructure data for at least partially automated driving of the motor vehicle is that the use of the infrastructure data is safe. “Safe” in the sense of the description particularly means “safe” and “secure”. Although these two English terms are usually translated into German as “sicher”, they nevertheless have a partially different meaning in English.

The term “safe” is particularly directed to the subject of accidents and accident prevention. Using the infrastructure data for at least partially automated driving of the motor vehicle, which is “safe”, means in particular that the probability of an accident or collision is less than or equal to a predetermined probability threshold. “Safe” in this sense means in particular that the correct functioning of the safety-related system is ensured b adequate measures.

The term “secure” is directed in particular at the topic of computer protection or hacker protection, i.e. in particular: How secure is an infrastructure or a computer infrastructure and/or a communication infrastructure, in particular a communication link between the motor vehicle and the infrastructure server, with regard to unauthorized access or data manipulation by third parties (“hackers”). The use of infrastructure data for at least partially automated driving of the motor vehicle, which is “secure”, is therefore based in particular on appropriate and sufficient computer protection or hacker protection.

In an embodiment, the at least one safety condition is provided to be an element selected from the following group of safety conditions: positive identity check of the motor vehicle and/or of the infrastructure, presence of a predetermined safety integrity level (SIL or – automotive safety integrity level – ASIL) in the motor vehicle and/or the infrastructure, presence of a predetermined safety integrity level in one or in a plurality of communication links between the motor vehicle and the infrastructure, presence of a predetermined safety integrity level in a communication component for establishing the communication link between the motor vehicle and the infrastructure, presence of a predetermined safety integrity level in the overall system comprising the motor vehicle and the infrastructure and, in particular, communication, presence of a predetermined safety integrity level in one or a plurality of parts, in particular component, algorithm, interface, of the motor vehicle and/or of the infrastructure, presence of a maximum latency time of a communication between the motor vehicle and the infrastructure, presence of a predetermined computer protection level of a device for carrying out the steps of the method according to the first and/or according to the second aspect, presence of a predetermined component and/or a predetermined algorithm and/or a predetermined communication option, which are used for carrying out the steps of the method according to the first and/or according to the second aspect, presence of redundancy and/or diversity in at least one predetermined component and/or at least one predetermined algorithm and/or at least one predetermined communication option, which are used to execute the steps of the method according to the first and/or according to the second aspect, presence of at least one predetermined availability indication which indicates an availability of at least one predetermined component and/or at least one predetermined algorithm and/or at least one predetermined communication option, presence of at least one predetermined quality criterion of the at least one predetermined component and/or the at least one predetermined algorithm and/or the at least one predetermined communication option, presence of at least one plan which comprises measures for reducing errors and/or measures in the event of failures of at least one predetermined component and/or at least one predetermined algorithm and/or at least one predetermined communication option and/or which comprises measures for misanalysis and/or which comprises measures in the event of misinterpretations, presence of one or several fallback scenarios, presence of at least one predetermined function, presence of a predetermined traffic situation, presence of a predetermined weather, maximum possible time for a respective performance or execution, respectively, of a step or of a plurality of steps of the method according to the first and/or according to the second aspect, presence of at least one test result which indicates that elements or functions, respectively, which are used to execute the method according to the first and/or according to the second aspect are currently functioning without errors. This e. g. results in the technical advantage that particularly suitable safety conditions are provided.

In an embodiment, log-on data are received via the communication network to log on the motor vehicle to an infrastructure server and to establish a communication link between the infrastructure server and the logged-on motor vehicle, wherein the infrastructure data are sent from the infrastructure server via the established communication link.

According to an embodiment, it is provided that the infrastructure data is sent via the established communication link only after the motor vehicle has successfully logged on to the infrastructure server, so that it is omitted to send the infrastructure data to a motor vehicle that is not logged on to the infrastructure server.

This e. g. achieves technical advantage that motor vehicles that are not logged on to the infrastructure server do not receive infrastructure data. In particular, this means that the infrastructure data are only sent to logged on vehicles, i.e. vehicles that are logged on to the infrastructure server.

According to an embodiment, it is provided to check whether at least one safety condition for an infrastructure-based support of an at least partially automated guided motor vehicle is fulfilled, wherein the infrastructure data is generated based on a result of the checking whether the at least one safety condition for an infrastructure-based supporting of an at least partially automated guided motor vehicle is fulfilled.

The foregoing discussion in connection with the at least one safety condition for the method according to the first aspect applies analogously to the at least one safety condition according to an embodiment according to the method according to the second aspect, and vice versa.

Generally, technical functionalities and technical advantages as mentioned in connection with the method according to the first aspect also apply in an analogous manner to the method according to the second aspect, and vice versa.

In an embodiment, it is provided to send the infrastructure data as a broadcast message or as a multicast message.

This e. g. achieves the technical advantage that infrastructure data may be efficiently sent over the communications network.

A broadcast message is a message sent by the infrastructure server to all subscribers of the communication network. A participant is e. g. the motor vehicle.

A multicast message refers to a message sent by the infrastructure server to a group of subscribers of the communication network. The participants of the group are in particular only logged on motor vehicles.

Infrastructure-based, at least partially automated driving of a motor vehicle particularly means that the motor vehicle is drive in at least a partially automated manner based on infrastructure data. Infrastructure-based thus particularly means support by an infrastructure server. These infrastructure data are made available to the motor vehicle, in particular via an infrastructure server. Infrastructure data e. g. include instructions to the motor vehicle. Infrastructure data e. g. includes information on an environment or surroundings of the motor vehicle. Infrastructure data e. g. include sensor data from one or a plurality of environmental sensors that are spatially distributed within the infrastructure.

In an embodiment, one or a plurality of environmental sensors are arranged on a respective infrastructural element of the infrastructure. An infrastructural element is e. g. one of the following infrastructural elements: streetlight, traffic sign, traffic sign bridge, utility pole, bridge, building, tunnel, traffic circle, intersection, particularly freeway access, freeway interchange, construction site, road section, in particular a dangerous and/or complicated road section.

In an embodiment, an environmental sensor in the sense of the description is one of the following environmental sensors: lidar sensor, radar sensor, ultrasonic sensor, magnetic field sensor, infrared sensor, and/or motion sensor. In particular, different environmental sensors may be used. This particularly comprises the technical advantage of redundancy and diversity. Infrastructure data e. g. include a target trajectory that the vehicle is to follow in an at least partially automated manner. Infrastructure data e. g. include weather data in a surrounding area or environment of the motor vehicle.

Infrastructure-based thus particularly means that the infrastructure server provides the motor vehicle with data, in this case the infrastructure data, on the basis of which the motor vehicle is or may be operated in an at least partially automated manner.

Infrastructure data e. g. include control commands for at least partially automated control of transverse and/or longitudinal operation of the motor vehicle. This means that using such control commands, the motor vehicle is or may be remotely controlled with the aid of the infrastructure server. This particularly means that the infrastructure server remotely controls or may remotely control the motor vehicle using such control commands. This means that the motor vehicle may be driven by the infrastructure server based on such control commands.

The phrase “at least partially automated driving” includes one or a plurality of the following: assisted driving, partially automated driving, highly automated driving, fully automated driving.

Assisted driving means that a driver of the motor vehicle permanently performs either the lateral or the longitudinal operation of the motor vehicle. The other driving task (i.e., controlling the longitudinal or lateral operation of the motor vehicle) is performed automatically. This means, therefore, that either the lateral or the longitudinal operation of the motor vehicle is controlled automatically during assisted driving of the motor vehicle.

Partially automated driving means that in a specific situation (e. g.: driving on a freeway, driving within a parking lot, overtaking an object, driving within a lane defined by lane markings) and/or for a certain period of time, longitudinal and lateral operation of the motor vehicle is controlled automatically. Drivers of the motor vehicle do not have to manually control the longitudinal and lateral operation of the motor vehicle themselves. However, drivers must permanently monitor the automatic control of the longitudinal and lateral operation in order to be able to intervene manually if necessary. Drivers must be ready to take over complete control of the vehicle at any time.

Highly automated driving means that for a certain period of time in a specific situation (e. g.: driving on a freeway, driving within a parking lot, overtaking an object, driving within a lane defined by lane markings), a longitudinal and a lateral operation of the motor vehicle are controlled automatically. Drivers of the motor vehicle do not have to manually control the longitudinal and lateral operation of the motor vehicle themselves. Drivers do not have to permanently monitor the automatic control of the longitudinal and lateral operation in order to be able to intervene manually if necessary. If necessary, a takeover request is automatically issued to the driver to take over control of the longitudinal and lateral operation, particularly issued with a sufficient time reserve. The driver must therefore potentially be able to take over control of the longitudinal and lateral operation. Limits of automatic control of the lateral and longitudinal operation are automatically detected. In the case of highly automated driving, it is not possible to automatically bring about a minimum-risk state in every initial situation.

Fully automated driving means that in a specific situation (e. g.: driving on a freeway, driving within a parking lot, overtaking an object, driving within a lane defined by lane markings), longitudinal and lateral operation of the motor vehicle is controlled automatically. Drivers of the motor vehicle do not have to manually control the longitudinal and lateral operation of the motor vehicle themselves. Drivers do not have to monitor the automatic control of the longitudinal and lateral operation in order to be able to intervene manually if necessary. Before automatic control of lateral and longitudinal operation is terminated, the driver is automatically prompted to take over the driving task (control of lateral and longitudinal operation of the motor vehicle), particularly with a sufficient time reserve. If the driver does not take over the driving task, the vehicle is automatically returned to a risk-minimized state. Limits of automatic control of lateral and longitudinal operation are automatically detected. In all situations, it is possible to automatically return to a risk-minimized system state.

According to an embodiment, one or a plurality of steps of the method according to the first aspect and/or according to the second aspect are documented, in particular documented in a blockchain. This e. g. has the technical advantage that even after the corresponding procedure has been carried out or executed, it may be analyzed retrospectively on the basis of the documentation. Documenting in a blockchain has the particular technical advantage that the documentation is tamper-proof and forgery-proof.

A blockchain is in particular a continuously expandable list of data records, called “blocks”, which are linked to one another with the aid of one or a plurality of cryptographic processes. Each block contains a cryptographically secure hash (scatter value) of the previous block, particularly a timestamp, and particularly transaction data.

In an embodiment, the infrastructure server is provided as part of a cloud infrastructure. In an embodiment, it is provided that the infrastructure server is arranged at an infrastructural element of the infrastructure.

In an embodiment, it is provided that the infrastructure server is adjacent, particularly directly adjacent, i.e. in proximity, to the traffic situation at hand, e. g. located at/in the tunnel.

In an embodiment, it is provided that a first infrastructure server is part of a cloud infrastructure and that a second infrastructure server is arranged adjacent, in particular directly adjacent, i.e. in proximity, to the present traffic situation, e. g. at/in the tunnel.

In an embodiment, it is provided that the infrastructure server is both part of a cloud infrastructure and adjacent, in particular immediately adjacent, i.e. in proximity, to the traffic situation at hand, for example at/in the tunnel.

According to an embodiment, it is provided that the method according to the first aspect and/or according to the second aspect is a computer-implemented method. According to an embodiment, it is provided that the method according to the first aspect and/or according to the second aspect is carried out or performed with the aid of the device according to the third aspect. Device features result analogously from corresponding process features and vice versa. This particularly means that technical functions of the device according to the third aspect analogously result from corresponding technical functionalities of the method according to the first aspect and/or according to the second aspect, and vice versa. Features of the method according to the first aspect analogously result from corresponding features of the method according to the second aspect, and vice versa. An embodiment comprises features of the method according to the first aspect and features of the method according to the second aspect. Thus, this particularly means that e. g. a combination of the method according to the first aspect and of the method according to the second aspect is preferably provided.

The phrase “at least one” particularly stands for “one or a plurality of”. The abbreviation “resp.” stands for “respectively”. The phrase “respectively” particularly stands for “and/or”.

Support by the infrastructure in the sense of the description is or comprises in particular support by a (remote) infrastructure server. If the infrastructure server is in the singular, the plural shall always be read along and vice versa. For example, an infrastructure server is located within the infrastructure.

The terms “vehicle” and “motor vehicle” may be used synonymously for the purposes of the description. The abbreviation “AD” stands for “automated driving”. An AD vehicle refers to a motor vehicle that is driven in an automated manner. When the phrase “AD vehicle” is used, it should always be read to indicate an at least partially automated motor vehicle.

Infrastructure data are particularly data that are not specific to a motor vehicle. This particularly means that the infrastructure data has not been determined specifically for a particular motor vehicle.

In the following, identical reference numerals may be used for identical features.

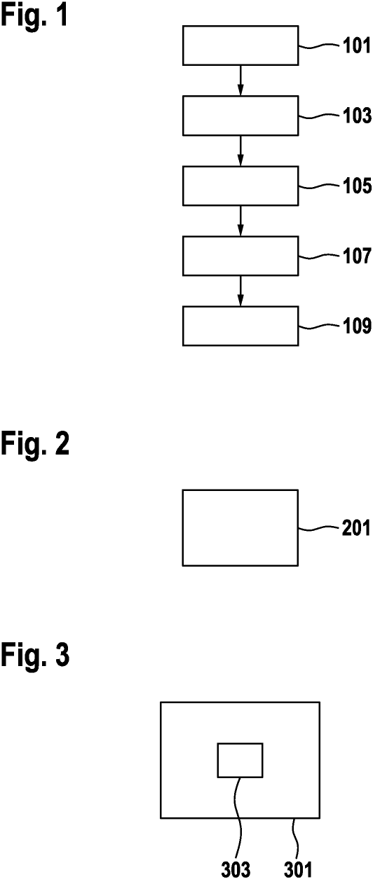

FIG. 1 shows a flowchart of a method for at least partially automated driving of a motor vehicle, comprising the following steps:
determining 101 that a need exists for infrastructure-based, at least partially automated driving of the motor vehicle,
transmitting 103, via a communication network, a request to transmit infrastructure data based on which the motor vehicle may be driven in an at least partially automated manner, in response to determining that a need exists for infrastructure-based at least partially automated guiding of the motor vehicle,
receiving 105, via the communication network, infrastructure data in response to the sending of the request, based on which the motor vehicle may be guided in an at least partially automated manner,
generating 107 control signals for at least partially automated control of lateral and/or longitudinal operation of the motor vehicle based on the infrastructure data,
outputting 109 of the generated control signals.

An embodiment provides that the transverse and/or longitudinal operation of the motor vehicle is controlled in an at least partially automated manner based on the output control signals.

FIG. 2 shows a device 201. The device 201 is set up to carry out any of the steps of the method according to the first aspect and/or the second aspect described below.

FIG. 3 shows a machine-readable storage medium 301. The machine-readable storage medium 301 is a non-transitory machine-readable storage medium. A computer program 303 is stored on the machine-readable storage medium 301. The computer program 303 comprises instructions that, when executed by a computer, cause the computer program 303 to perform a method according to the first aspect and/or according to the second aspect.

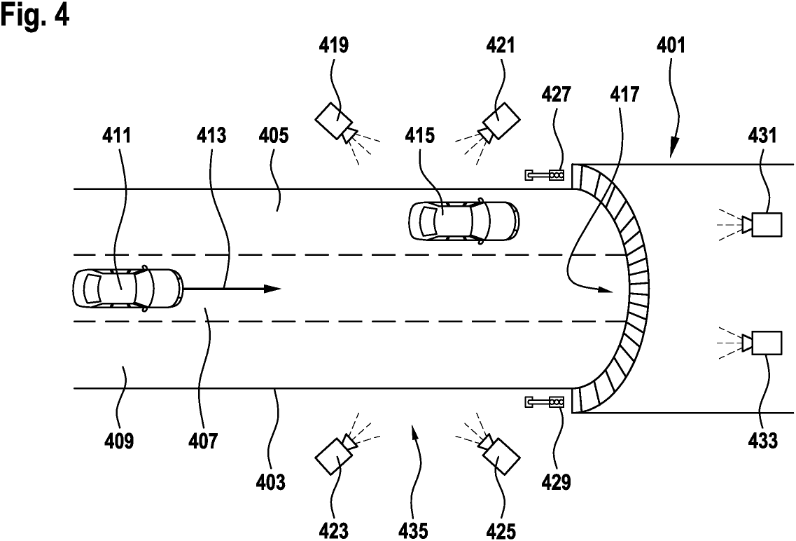

FIG. 4 shows a first tunnel 401 through which a road 403 passes. The road 403 has a first lane 405, a second lane 407, and a third lane 409. A first motor vehicle 411 travels in the center lane 407. A direction of travel of the first motor vehicle 411 is indicated by an arrow having reference numeral 413. A second motor vehicle 415 is traveling in the left lane 405 ahead of the first motor vehicle 411. A first video camera 419, a second video camera 421, a third video camera 423, and a fourth video camera 425 are spatially distributed around or in the vicinity of an entrance 417 of the first tunnel 401.

The first video camera 419 and the third video camera 423 capture the entrance 417 and e. g. at least an area in the first tunnel 401 that is behind the entrance 417. The second video camera 421 and the fourth video camera 425 capture a vicinity of the entrance 417, with these two video cameras facing away from the entrance 417, whereas the first video camera 419 and the third video camera 423 face toward the entrance 417.

Furthermore, to the left of entrance 417, a first traffic signal 427 is arranged and to the right of entrance 417, a second traffic signal 429 is arranged.

A fifth video camera 431 is located within the first tunnel 401 itself, and a sixth video camera 433 is located within the first tunnel 401, which are not visible from outside the first tunnel 401, but these two video cameras 431, 433 are nevertheless shown for ease of illustration. These two video cameras 431, 433 are oriented toward the entrance 417 and capture a corresponding area within the first tunnel 401.

The corresponding video signals or video images from these cameras may e. g. be sent to the first motor vehicle 411 and/or the second motor vehicle 415 as an example of infrastructure data.

Furthermore, according to an embodiment, it may be provided that the video images from these video cameras are analyzed to detect potential problems, e. g. collision objects, e. g. a traffic jam within the first tunnel 401.

According to an embodiment, a result of this analysis may be sent to the first or second motor vehicle 411, 415 as an example of infrastructure data.

Furthermore, according to an embodiment, it may be provided that, based on an analysis of the video images, the two traffic signal systems 427, 429 are operated. For example, it may be provided to control the two light signal systems 427, 429 in such a way that they emit a red signal image if a problem, e. g. a collision object, e. g. a traffic jam within the first tunnel 401 has been detected. For example, according to an embodiment, it may be provided to send an instantaneous signal image of the two traffic signals 427, 429 as an example of infrastructure data to the first motor vehicle 411 or to the second motor vehicle 415, respectively.

Based on the exemplary infrastructure data as set forth above, the two motor vehicles 411, 415 may e. g. be guided in an at least partially automated manner. In this respect, these two motor vehicles 411, 415 may be guided in an infrastructure-based manner, at least in a partially automated manner, when traveling through a tunnel.

Instead of a tunnel, the following infrastructural elements may e. g. be provided by which a motor vehicle is to be operated in an analogous infrastructure-based, at least partially automated manner: Construction site, bridge, freeway intersection, freeway access, freeway exit, intersection, generally junction, in particular junction in urban areas.

The six video cameras as well as the traffic light system 427 and the traffic light system 429 are thus part of an infrastructure 435 by which a motor vehicle may be guided through the first tunnel 401 in an at least partially automated manner.

In an embodiment not shown, one or a plurality of the following environmental sensors may be used instead of or in addition to the respective video cameras: lidar sensor, radar sensor, ultrasonic sensor, and/or motion sensor. In particular, different environmental sensors may be used. This particularly has the technical advantage of redundancy and diversity.

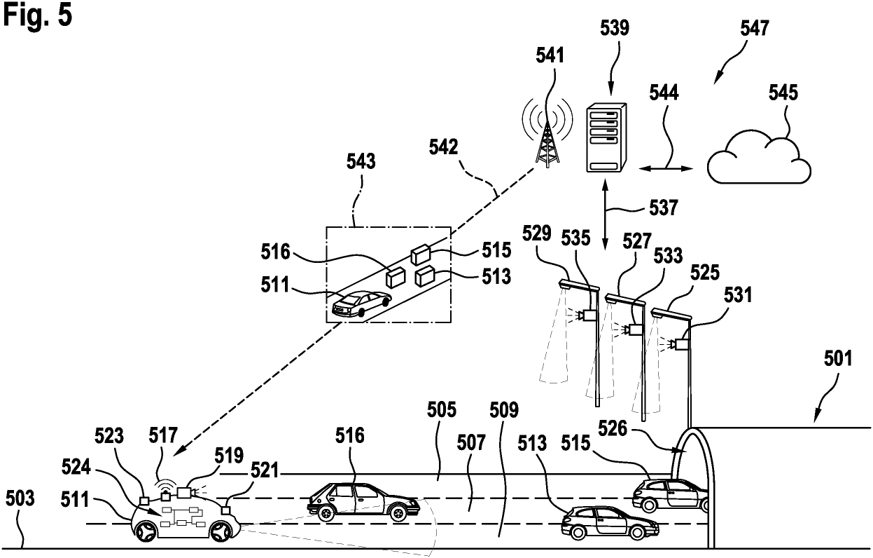

FIG. 5 shows a second tunnel 501. A road 503 leads through the second tunnel 501. The road 503 has a first lane 505, a second lane 507, and a third lane 509. A direction of travel for motor vehicles traveling on road 503 through second tunnel 501 is from left to right with respect to the paper plane. With respect to this direction of travel, the first lane 505 is the left lane and the second lane 507 is the center lane and the third lane 509 is the right lane. A first motor vehicle 511 and a second motor vehicle 513 are traveling in the right lane 509. A third motor vehicle 515 and a fourth motor vehicle 516 travel in the center lane 507.

For example, the first motor vehicle 511 has the following components or systems: communication device 517, roof-installed video camera 519, front side radar sensor 521, rear side radar sensor 523. Reference numeral 524 points to a plurality of squares comprised by the first motor vehicle 511, said plurality of squares being intended to symbolize further components of the motor vehicle 511, e. g. actuators, sensors, control devices, which are e. g. required to allow for the motor vehicle 511 to be driven in an at least partially automated manner.

Furthermore, a first streetlight 525, a second streetlight 527, and a third streetlight 529 are disposed in the vicinity of an entrance or driveway 526 of the second tunnel 501. A first video camera 531 is arranged at the first streetlight 525. A second video camera 533 is arranged at the second streetlight 527. A third video camera 535 is arranged at the third streetlight 529.

In an embodiment not shown, the three video cameras are arranged on a respective infrastructural element. An infrastructural element is e. g. one of the following infrastructural elements: street light, traffic sign, traffic sign bridge.

In an embodiment not shown, one or a plurality of the following environmental sensors may be used instead of or in addition to the respective video cameras: lidar sensor, radar sensor, ultrasonic sensor, and/or motion sensor. In particular, different environmental sensors may be used. This particularly has the technical advantage of redundancy and diversity.

These three video cameras capture video images of the entrance 526 or a vicinity of the entrance 526 outside of the second tunnel 501. The corresponding video images are sent to a data processing device 539 via a first encrypted communication link 437. The data processing device 539 analyzes these video images or video signals and e. g. sends a result of this analysis to the first motor vehicle 511 via an encrypted connection 542 with the aid of a second communication device 541.

The result of the analysis is symbolically indicated by reference numeral 543. It e. g. comprises an object list of objects detected via the three video cameras. For example, the detected or detected objects are shown in a digital environment model of the area surrounding the driveway 526.

The result of this analysis is thus an example of infrastructure data which are sent to the first motor vehicle 511 so that the first motor vehicle 511 may drive through the second tunnel 501 in an at least partially automated manner based on these data and in particular additionally based on motor vehicle data.

The data processing device 539 e. g. communicates with a cloud infrastructure 545 via a third communication link 544. The third communication link 544 may also be an encrypted communication link. For example, analysis steps of an analysis of the video images may be carried out in the cloud infrastructure 545. For example, the cloud infrastructure 545 may provide memory to store the video images.

In this respect, the three video cameras 531, 533, 535, the data processing device 539, and the second communication device 541 are part of an infrastructure 547 that may assist or support the first motor vehicle 511 in at least partially automated driving.

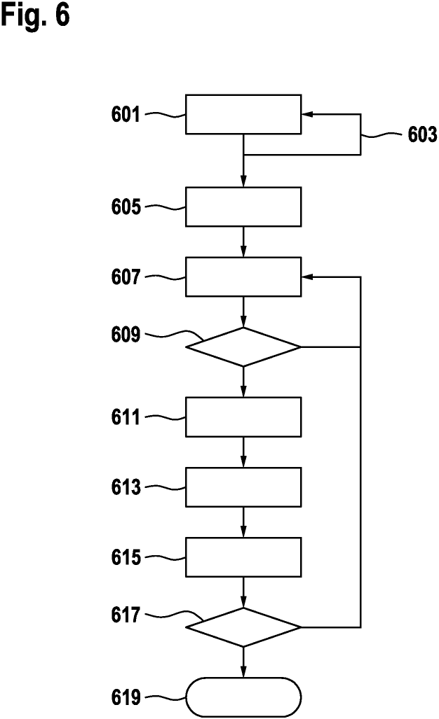

FIG. 6 shows a flowchart of a method.

According to a step 601, an environment analysis is provided on the infrastructural side. This particularly means that, according to step 601, environmental sensors that are spatially distributed within an infrastructure detect their respective environment and provide environmental sensor data corresponding to the respective detection. The environment analysis comprises an analysis of these environmental sensor data. This environment analysis is performed continuously or periodically, as indicated by a corresponding arrow in the flowchart by reference numeral 603.

According to a step 605, it is provided that the motor vehicle logs on to an infrastructure server of the infrastructure in order to request support for at least partially automated driving of the motor vehicle through the infrastructure. That is, in step 605, logon data are sent from the motor vehicle to the infrastructure server to log on to the infrastructure server and establish a communication link to it.

According to a step 607, it is provided that a check for a secure login or communication connection is performed. For example, in step 607 a check is carried out whether one or a plurality of security conditions are met so that the motor vehicle may be supported by the infrastructure via infrastructure data in the at least partially automated driving task.

According to step 609, it is determined whether the verification according to step 607 has determined a positive or negative result. A positive result indicates that the logon or communication link is secure. A negative result indicates that the logon or communication connection is not secure, i.e. insecure.

If the result is negative, the method continues at step 607. The background to this is particularly that support from the infrastructure is a preferred objective. Therefore, new attempts should be undertaken to obtain this support.

If the result is positive, the method continues at step 611. According to step 611, it is provided that infrastructure data is sent from the infrastructure server to the logged-on motor vehicle. If several motor vehicles are logged on to the infrastructure server, step 611 e. g. provides that the infrastructure data are sent to all logged on motor vehicles. Infrastructure data e. g. comprise environment information determined on the basis of the environment analysis according to step 601.

According to a step 613, it is provided that the motor vehicle fuses the received infrastructure data with its own data. These data are the aforementioned motor vehicle data and e. g. comprise environmental sensor data from environmental sensors of the motor vehicle. This means that the received infrastructure data are processed with the motor vehicle data. The processing particularly comprises using a position of the motor vehicle or a localization of the motor vehicle. This means, for example, that the localization of the motor vehicle may be verified based on the fusion of the data from the infrastructure and the motor vehicle.

Processing also or especially comprises the analysis of the environment based on the fused data (motor vehicle and infrastructure) – e. g. looking for other motor vehicles and objects on the route / road – that could lead to a dangerous situation (e. g. accident)

A step 615 follows, according to which planning and then a corresponding implementation of the at least partially automated driving task is performed based on the fused data. The implementation of the at least partially automated driving task comprises generating corresponding control signals for at least partially automated control of lateral and/or longitudinal operation of the motor vehicle. This particularly means that the motor vehicle is e. g. accelerated, decelerated, steered, e. g. an evasive maneuver is performed.

According to a step 617, a check is carried out as to whether further support by the infrastructure is necessary for the at least partially automated driving task. If this is the case, the method continues at step 607.

The background here is in particular that as long as the support by the infrastructure is used, according to an embodiment, particularly always, one or a plurality of the following steps are carried out again, particularly until the present traffic situation no longer makes it possible or necessary and / or the infrastructure support is no longer necessary or possible:

Checking whether communication (still) exists between the vehicle and the infrastructure. This could have been interrupted in the meantime, after all.

Checking whether the safety conditions are still complied with.

Checking whether the infrastructure data is (still) correct.

Retrieving or using the infrastructure data.

The above-described step of merging.

The above-described step 615 (determining planning/action data and implementing action).

Provided that no further support is required by the infrastructure for the at least partially automated driving task, the method ends at block 619.

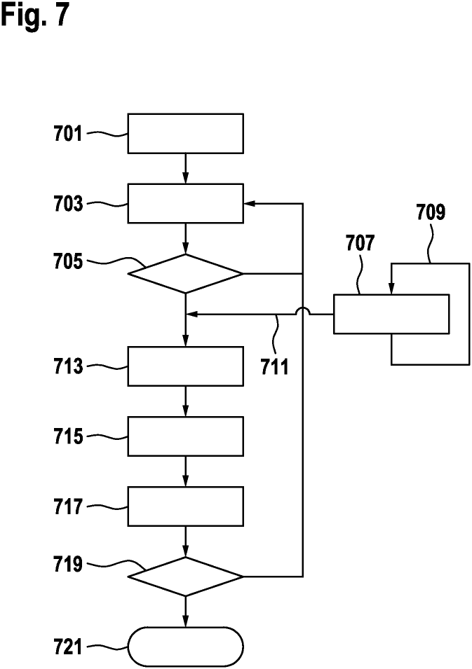

FIG. 7 shows a flowchart of a further method.

Step 701 corresponds to step 605 according to the flowchart of FIG. 6. Step 703 corresponds to step 607 of the flowchart of FIG. 6. Step 705 corresponds to step 609 of the flowchart of FIG. 6. Step 707 corresponds to step 601 of the flowchart of FIG. 6. As is the case with reference numeral 603 of the flowchart according to FIG. 6, the arrow with reference numeral 709 according to the flowchart according to FIG. 7 is to symbolize that this environment analysis is performed continuously or periodically. The corresponding infrastructure data are made available to logged on motor vehicles for further use or provision, which is symbolically indicated by an arrow with the reference numeral 711.

Step 713 corresponds to step 611 of the flowchart of FIG. 6. Step 715 corresponds to step 613 of the flowchart of FIG. 6. Step 717 corresponds to step 615 of the flowchart of FIG. 6. Step 719 corresponds to step 617 of the flowchart of FIG. 6. Block 721 corresponds to block 619 of the flowchart of FIG. 6.

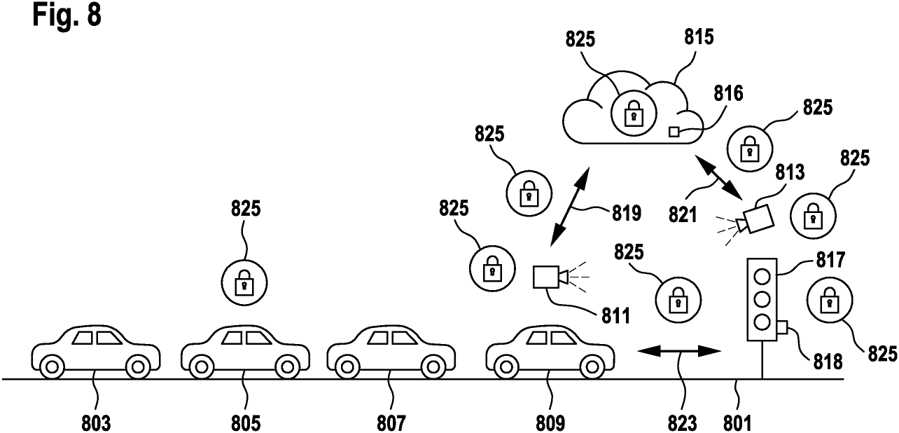

FIG. 8 shows a road 801 on which a first motor vehicle 803, a second motor vehicle 805, a third motor vehicle 807, and a fourth motor vehicle 809 are traveling. Two video cameras, a first video camera 811 and a second video camera 813, are provided that are located in the vicinity of the road 801 and monitor sections of the road 801. It is noted that the two video cameras 811, 813 are examples of perimeter sensors. In an embodiment not shown, additional perimeter sensors are provided instead of or in addition to the two video cameras 811, 813. The two video cameras 811, 813 communicate with a cloud infrastructure 815 that comprises a first infrastructure server 816. Furthermore, a traffic signal 817 is arranged at the road 801, at which a second infrastructure server 818 is arranged.

A communication link between the first video camera 811 and the cloud infrastructure 815 is symbolically indicated by a double arrow having reference numeral 819. A communication link between the second video camera 813 and the cloud infrastructure 815 is symbolically indicated by a double arrow having reference numeral 821. Via these two communication links 819, 821, the two video cameras 811, 813 may e. g. each send recorded video images to the cloud infrastructure 815, in particular to the first infrastructure server 816. Based on these video images, the first infrastructure server 816 may e. g. perform an environmental analysis.

The second motor vehicle 805 and the fourth motor vehicle 809 e. g. log on to the first infrastructure server 816 and/or the second infrastructure server 818. A communication link correspondingly established as a result between these motor vehicles and the second infrastructure server 818 is symbolically indicated by a double arrow having reference numeral 823. It is noted that, for the sake of clarity, no double arrow has been drawn for a communication link between these two motor vehicles 805, 809 and the first infrastructure server 816. Nevertheless, such a communication link is provided between these two motor vehicles 805, 809 and the first infrastructure server 816 according to an embodiment.

For example, via the communication link 823, the second infrastructure server 818 may send or communicate information about a current and/or future signaling state of the traffic signal system 817 to the two logged on motor vehicles 805, 809. This information is an example for infrastructure data in the sense of the description.

For example, the second infrastructure server 818 transmits a remaining time duration of a current green or red phase of the traffic signal 817.

Symbols with the reference numeral 825 are drawn in FIG. 8 to represent a lock in order to make it clear that the individual communication links and the transmitted information and data are encrypted. This means, therefore, that an encrypted communication link is established between the individual communication participants or partners. This therefore means that the individual information or data is stored in encrypted form.

In an embodiment, the “key symbol” not only means safe (secure or encrypted), but may also mean that the communication or the entire process is safe; hence, a “summary” of the steps secure login, secure communication, secure / correct data, safe-topics (the security conditions described here), etc. This may therefore mean that the key symbol 825 is intended to indicate that one or a plurality of specified or predetermined security conditions have been met.

According to the embodiment example shown in FIG. 8, only the two motor vehicles 805, 809 are logged on to the two infrastructure servers 816, 818. Only these two motor vehicles 805, 809 receive infrastructure data from the infrastructure servers 816, 818 to support an at least partially automated driving task.

The first motor vehicle 803 and the third motor vehicle 807 are not logged on and in this respect do not receive infrastructure data.

In an embodiment not shown, it may be provided that, although the first motor vehicle 803 and the third motor vehicle 807 are not logged on, they nevertheless receive infrastructure data from the first infrastructure server 816 and the second infrastructure server 818, wherein it is particularly provided that the use of this infrastructure data in the corresponding motor vehicles 803, 807 is restricted. The restriction may e. g. comprise that the infrastructure data is not used for the at least partially automated driving task, but only serves information purposes or warning purposes. For example, it is provided that for the non-logged-on motor vehicles 803, 807 the correspondingly transmitted infrastructure data is marked as non-secure, i. e. as unsafe, so that a control unit in the motor vehicle 803 or 807 will not use this data marked as unsafe for the at least partially automated driving task. The reason for this is in particular that this data is marked as insecure because the motor vehicles 803, 807 are not logged on and in this respect no verification has taken place as to whether at least one security condition is fulfilled.

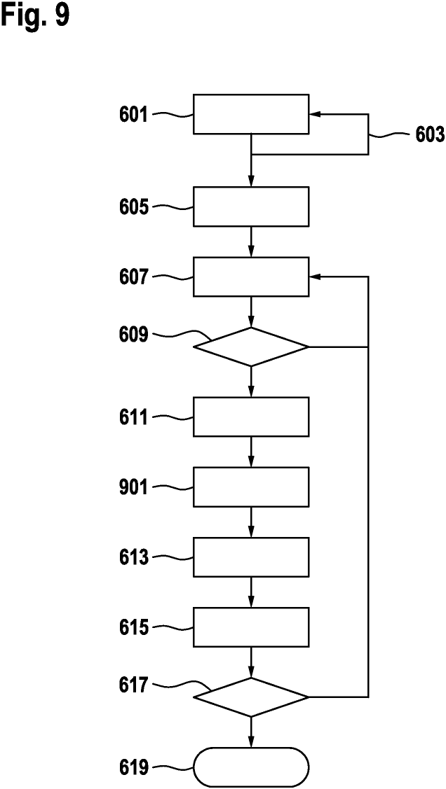

FIG. 9 shows a flowchart of a further method. The flowchart is essentially identical to the flowchart shown in FIG. 6. An additional step 901 is provided between step 611 and step 613. According to step 901, the infrastructure data is checked for correctness. This check particularly takes place in particular in the motor vehicle. For example, the infrastructure data is checked for plausibility.

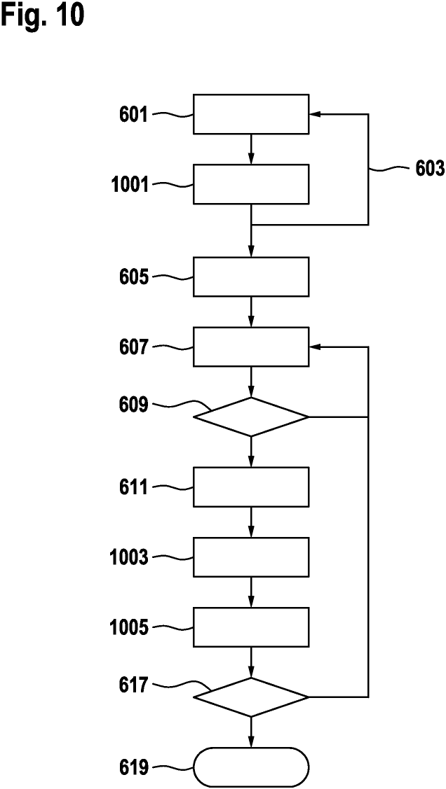

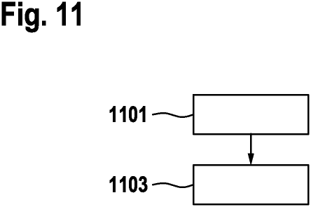

FIG. 10 shows a flowchart of a further process. The flowchart according to FIG. 10 is essentially identical to the flowchart shown in FIG. 6. An additional step 1001 is provided between step 601 and step 605. According to step 1001, the current specifications or conditions to which the motor vehicle is exposed or subject are analyzed on the infrastructural side. Such specifications or conditions e. g. comprise a tunnel closure, a lane closure or similar driving restrictions. Corresponding analysis results are also sent to the logged-on motor vehicle in step 611.

Furthermore, a step 1003 and a step 1005 are provided, which are performed one after the other between steps 611 and 617.

Step 1003 is essentially the same as step 613 of the flowchart of FIG. 6, with the addition of using the transmitted specifications or conditions in the corresponding data processing or data fusion.

Step 1005 essentially corresponds to step 615 of the flowchart of FIG. 6, although here the transmitted specifications or conditions are additionally taken into account for the planning and implementation of the at least partially automated driving task.

FIG. 11 shows a flowchart of a method for infrastructure-based support of a motor vehicle driven in an at least partially automated manner, comprising the following steps:
receiving 1101 a request to send infrastructure data via a communication network, based on which the motor vehicle may be driven in an at least partially automated manner,
transmitting 1103 infrastructure data in response to receiving the request via the communication network, based on which the motor vehicle may be driven in an at least partially automated manner.

An embodiment provides that an AD vehicle is to drive safely into a tunnel. For this purpose, the AD vehicle receives processed data (infrastructure data) in good time before entering the tunnel, which it e. g. uses as an additional sensor and e. g. fuses into its local vehicle environment model. The decision about the use and meaning of the received environment model remains in the AD vehicle. For example, the infrastructure fuses the data from the sensors (e. g., cameras, radars, lidars) mounted in the tunnel entrance area into an infrastructure-local environment model. The environment model is e. g. distributed by a so-called “Roadside Unit (RSU)”, i. e. a communication unit located in proximity of the road, preferably in the form of a list of all relevant objects and obstacles in the area of the tunnel entrance to all AD vehicles in the vicinity.

In an embodiment, this is done cyclically via wireless direct communication using “broadcast”. This means that the same information is sent to all vehicles. The tunnel infrastructure will not guide the AD vehicle (e. g., by specifying a safe driving corridor) and will e. g. not take control of the vehicle. Decisions on driving strategy and driving maneuvers e. g. remain with the AD vehicle.

In an embodiment, in addition to the embodiment described above with regard to the tunnel entrance, information about the signaling states of a tunnel traffic light is transmitted to the AD vehicle (e. g. via broadcast). This may be done cyclically via wireless direct communication by an RSU positioned locally in the vicinity of the tunnel entrance. For tests, e. g. a situation analogous to tunnel closure or clearance is generated by the traffic control center. Similarly, the decision on the influence and use of the signaling states of a traffic signal system e. g. remains in the AD vehicle at all times.

The concept described herein comprises a method by which, for example, the tunnel scenario (driving in, driving through and/or driving out) may be carried out safely – including safety-critical actions – and with the assumption of responsibility. The concept may e. g. also be applied to one or to a plurality of the following traffic situations, e. g., construction sites, bridges, freeway accesses, freeway interchanges, dangerous/complex road sections. The tunnel is an exemplary example.

In an embodiment, an “environment analysis” step is provided, according to which the infrastructure analyzes the environment. I.e., the infrastructure analyzes the environment with regard to all road users (e. g., vehicles, motorcycles, pedestrians, etc.) as well as to the presence of objects on and next to the road, including their effects on road traffic. In an embodiment, the infrastructure creates an environment model from the infrastructure data, e. g., in the form of an object list. In addition to positions and dimensions, the object information can comprise data on changes over time (speed, acceleration).

In a further embodiment, the infrastructure for the objects predicts the presumed further movements (trajectory, further/future velocity, further/future acceleration).

The analysis of the environment may be repeated again and again. This means, the step may e. g. be performed as a parallel process that is repeated over and over again.

For example, when checking for a secure login/transfer, the following is verified:

Are the communication partners who they claim to be and suitable/authorized for the process? This may e. g. be done via certificates.

Are necessary framework conditions for support met? For example: Do the systems (vehicle, infrastructure) work correctly? Do the systems have sufficiently safe components (e. g. ASIL C or D)? Are all safety conditions (e. g., weather, speed) met? Is support currently authorized?

In an embodiment, it is provided that the infrastructure data are sent only to logged on AD vehicles by the infrastructure. The background to this is in particular that in the “log-on/verification” step, it is analyzed whether the AD vehicle can or is allowed to use the infrastructure data for safety-critical actions (without having a driver as a fallback or as the person/system responsible).

The infrastructure data sent to the vehicle are up to date, since the infrastructure e. g. updates it continuously (see above).

To increase security even further, the process may e. g. be extended with an additional step “Check for correctness”. Here, for example, the data in the vehicle is checked for “Is this possible / does this makes sense at all?” is checked.

In an embodiment, the “log-on/verification” or “correctness” step(s) is documented to provide evidence in the event of product liability issues, preferably using a tamper-proof method (e. g., blockchain).

In a further embodiment, further relevant data is documented in a tamper-proof manner.

As may be seen in the process flow, the same infrastructure data, which in particular is not vehicle-specific, is sent from the infrastructure to all logged on AD vehicles, e. g. by a broadcast message. This means that the AD vehicles receive the environment data from the infrastructure and e. g. localize themselves and/or decide on their own actions based on the fused information (infrastructure data) from the infrastructure and based on motor vehicle data from their own vehicle itself.

The background to this is in particular that the infrastructure has no information on e. g., which vehicle is which vehicle - i.e.: which is a logged-on vehicle and which is not a logged on vehicle, which of the logged on vehicles is e. g. traveling where (lane, position in the lane, etc.), which of the logged on vehicles is e. g. traveling how (speed, next actions, etc.).

In an embodiment, the infrastructure may additionally analyze or determine and additionally dispatch specifications, e. g., tunnel is closed, lane is closed, driving specifications (e. g., speed). The specifications must then be e. g. implemented by the logged-on AD vehicle(s) (e. g., stop before the tunnel). How the implementation is carried out is e. g. analyzed and planned by the AD vehicle itself.

In a further embodiment, the data may also be sent to other vehicles (non-safe/approved vehicles or non-AD vehicles).

One difference here is, for example, that these vehicles may/can only use the data for information / comfort / warning functions. This e. g. means that a driver is present in the driving process and is responsible for it. This process is again, in an embodiment, documented in a tamper-proof manner.

For example, the concept may be applied to one or to a plurality of the following traffic situations, e. g., construction sites, bridges, freeway accesses, freeway interchanges, hazardous/complex road sections.

The invention provides a concept on the basis of which a motor vehicle may be efficiently driven in an at least partially automated manner. By providing the motor vehicle with infrastructure data for at least partially automated driving of the motor vehicle, additional information external to the motor vehicle is available to the motor vehicle for this driving task, i.e. for at least partially automated driving, over and above information generated internally in the motor vehicle.

What is claimed is:

1. A method for at least partially automated driving of a motor vehicle, comprising the following steps:
determining that a need exists for infrastructure-based, at least partially automated driving of the motor vehicle;
transmitting, via a communication network, a request to transmit a plurality of infrastructure data based on which the motor vehicle is drivable in an at least partially automated manner, in response to determining that a need exists for infrastructure-based, at least partially automated driving of the motor vehicle;
receiving, via the communication network, the infrastructure data in response to transmitting the request, based on which the motor vehicle is operable in the at least partially automated manner;
generating a plurality of control signals for at least partially automated controlling of a lateral and/or a longitudinal operation of the motor vehicle based on the infrastructure data; and
outputting the control signals generated in the generating step.

2. The method of claim 1, wherein a plurality of position signals representing a position of the motor vehicle are received and determining that a need exists for infrastructure-based, at least partially automated driving of the motor vehicle is performed based on the position of the motor vehicle.

3. The method of claim 1, wherein, in response to determining that the need exists for infrastructure-based, at least partially automated driving of the motor vehicle, a plurality of log-on data are sent over the communications network to log on the motor vehicle to a remote infrastructure server and to establish a communication link between the infrastructure server and the logged on motor vehicle.

4. The method of claim 3, wherein the infrastructure data are received from the infrastructure server via the communication link.

5. The method of claim 1, wherein the infrastructure data are checked and the control signals are generated based on a result of checking the infrastructure data.

6. The method of claim 1, wherein a plurality of motor vehicle data signals representing a plurality of motor vehicle data generated by the motor vehicle are received, and the infrastructure data is fused with the motor vehicle data to determine a plurality of infrastructure motor vehicle data, the control signals are generated based on the infrastructure motor vehicle data.

7. The method of claim 1, wherein it is checked whether at least one safety condition for the infrastructure-based, at least partially automated driving of the motor vehicle is fulfilled.

8. The method of claim 7, wherein the control signals are generated based on a result of checking whether the at least one safety condition for the infrastructure-based, at least partially automated driving of the motor vehicle is fulfilled.

9. The method of claim 7, wherein the at least one safety condition is an element selected from the following group of safety conditions: a positive identity check of the motor vehicle and/or of an infrastructure, presence of a predetermined safety integrity level in the motor vehicle and/or in the infrastructure, presence of a predetermined safety integrity level in one or a plurality of communication links between the motor vehicle and the infrastructure, presence of a predetermined safety integrity level in a communication component for establishing a communication link between the motor vehicle and the infrastructure, presence of a predetermined safety integrity level in an overall system comprising the motor vehicle and the infrastructure, presence of a predetermined safety integrity level in one or in a plurality of parts, in particular component, algorithm, interface, of the motor vehicle and/or of the infrastructure, presence of a maximum latency of a communication between the motor vehicle and the infrastructure, presence of a predetermined computer protection level of a device for carrying out the steps of the method, presence of a predetermined component and/or a predetermined algorithm and/or a predetermined communication option used to perform the steps of the method, presence of redundancy and/or diversity in at least one predetermined component and/or at least one predetermined algorithm and/or at least one predetermined communication option, which are used to carry out the steps of the method, presence of at least one predetermined availability indication which indicates an availability of at least one predetermined component and/or at least one predetermined algorithm and/or at least one predetermined communication option, presence of at least one predetermined quality criterion of the at least one predetermined component and/or the at least one predetermined algorithm and/or the at least one predetermined communication option, presence of at least one plan which comprises measures for the reduction of errors and/or measures in the event of failures of at least one predetermined component and/or at least one predetermined algorithm and/or at least one predetermined communication option and/or which comprises measures for misanalysis and/or which comprises measures in the event of misinterpretations, presence of one or a plurality of fallback scenarios, presence of at least one predetermined function, presence of a predetermined traffic situation, presence of a predetermined weather, maximum possible time for a respective performance or execution, respectively, of a step or of a plurality of steps of the method according to any one of the preceding claims , presence of at least one test result which indicates that elements or functions, respectively, which are used to execute the method are currently functioning without errors.

10. A method for infrastructure-based support of a motor vehicle driven in an at least partially automated manner, comprising the following steps:
receiving a request to send a plurality of infrastructure data via a communication network, based on which the motor vehicle may be guided in an at least partially automated manner; and
transmitting the infrastructure data in response to receiving the request via the communication network, based on which the motor vehicle is drivable in the at least partially automated manner.

11. The method of claim 10, wherein a plurality of log-on data are received over the communication network to log on the motor vehicle with an infrastructure server and establish a communication link between the infrastructure server and the motor vehicle, the infrastructure data is sent from the infrastructure server over the communication link.

12. The method of claim 11, wherein the infrastructure data is sent via the communication link only after the motor vehicle has successfully logged on to the infrastructure server.

13. The method of claim 10, wherein it is checked whether at least one safety condition for an infrastructure-based supporting of a motor vehicle driven in the at least partially automated manner is fulfilled.

14. The method of claim 13, wherein the infrastructure data is generated based on a result of the check whether the at least one safety condition for the infrastructure-based supporting of the at least partially automated guided motor vehicle is fulfilled.

15. The method of claim 10, wherein the infrastructure data is sent as a broadcast message or as a multicast message.

16. A device carrying out the method of claim 1.

17. A computer program comprising a plurality of commands that, when executed by a computer, cause the computer program to perform the method of claim 1.

18. A machine-readable storage medium on which the computer program of claim 17 is stored.
